(19) United States
(12) Patent Application Publication
(10) Pub. No.: US 2022/0097013 A1
(43) Pub. Date: Mar. 31, 2022

(54) AGITATOR FOR MEASURING PROCESS PARAMETERS IN A WIRELESS AND/OR BATTERY-FREE MANNER

(71) Applicant: Fraunhofer-Gesellschaft zur Foerderung der angewandten Forschung e.V., Munich (DE)

(72) Inventors: Andreas WEDER, Dresden (DE); Andreas HEINIG, Dresden (DE)

(21) Appl. No.: 17/549,339

(22) Filed: Dec. 13, 2021

Related U.S. Application Data
(63) Continuation of application No. PCT/EP2020/066361, filed on Jun. 12, 2020.

(30) Foreign Application Priority Data
Jun. 14, 2019 (DE) 10 2019 208 738.8

(51) Int. Cl. B01F 27/051; B01F 35/214; B01F 35/22

(52) U.S. Cl. CPC B01F 27/051; B01F 23/233; B01F 35/22; B01F 35/2142

(57) ABSTRACT

An agitator is configured to move within a vessel in order to circulate at least one substance, the agitator including at least one sensor, the sensor being configured to detect parameters of the circulating process and/or parameters of the substance and/or parameters of an reaction and/or parameters of the agitator, and agitator being configured to supply energy to at least one sensor in a wireless manner and to transmit sensor signals to an evaluating device.

The invention further relates to an agitator system with such an agitator and a method for detecting and measuring, respectively, process parameters in a wireless and/or battery-free manner.

### CROSS-REFERENCES TO RELATED APPLICATIONS

This application is a continuation of copending International Application No. PCT/EP2020/066361, filed Jun. 12, 2020, which is incorporated herein by reference in its entirety, and additionally claims priority from German Application No. DE 10 2019 208 738.8, filed Jun. 14 2019, which is/ incorporated herein by reference in its entirety.

Embodiments of the invention relate to an agitator for measuring process parameters in a wireless and/or battery-free manner, as well as an agitator system comprising such an agitator and a method for using such an agitator in an agitator system.

### BACKGROUND OF THE INVENTION

Agitators for the preparation or transformation of substances by circulating or mixing the substances have been known for a long time. They are used, for example, in the preparation of polymers in chemical reactors or vessels for agitating. In production and in laboratory test stands, precise control of process parameters-13 primarily temperature—is desirable in order to achieve or optimize a certain quality and quantity. In this case, the use of radio systems such as Bluetooth, WiFi or ZigBee for transmitting radio signals from a sensor is not possible, since a power supply in the closed reactor cannot be ensured via batteries due to high process temperatures and the radio signal cannot penetrate the reactor due to a metallic structure. Furthermore, often substances are used which react in aqueous solution and which attenuate the radio signal so much that, for example, no signals can be transmitted from a bottom of the chemical reactor. At present, temperature measuring rods—thermocouples—are inserted in a wired manner into the chemical reactor in order to detect a temperature of the substances or the process during operation.

Such thermocouples often interfere with the process and make handling and cleaning of the agitators and chemical reactors difficult. In addition, the temperature measuring rods influence or hinder the reaction to be tested and/or contaminate the reactants in the vessel of the reactor with old adhesions.

It is therefore desirable to provide an agitator or an agitator system that allows flexible use and easy handling in chemical reactors for the transformation and simultaneous detection of parameters of substances and their reaction. Furthermore, the agitator should also be capable of alternatively or additionally detecting and/or transmitting parameters of the agitator or the agitator system itself.

### SUMMARY

An embodiment may have an agitator, wherein the agitator is configured to move within a vessel in order to circulate at least one substance, wherein the agitator includes at least one sensor which is configured to detect parameters of the circulating process and/or parameters of the substance and/or parameters of a reaction and/or parameters of the agitator, and wherein the agitator is configured to transmit sensor signals of the at least one sensor to an evaluating device in a wireless manner, wherein the at least one sensor is configured to detect the parameters in an intermittent manner, wherein the agitator includes at least one further sensor being configured to detect parameters of the circulating process and/or detect parameters of the agitator, wherein the sensors are arranged at different points of the agitator, and sensors detecting the parameters of the agitator itself are arranged at points where high mechanical loads occur, and sensors detecting parameters of a concentration of the substances to be circulated are arranged in the vicinity of extremities of a rotating circulator of the agitator.

According to another embodiment, an agitator system may have: an inventive agitator; a vessel configured to receive the agitator and the substances to be agitated by the agitator; a drive configured drive the agitator.

Another embodiment may have a method for agitating at least one substance, wherein an inventive agitator is moved within a vessel in order to circulate at least one substance, and wherein, during movement of the agitator, a sensor signal received by a sensor arranged in or at the agitator is transmitted to an evaluating device in a wireless manner, wherein the at least one sensor detects the parameters in an intermittent manner, wherein at least one further sensor detects parameters of the circulating process and/or detect parameters of the agitator, wherein the sensors are arranged at different points of the agitator, and sensors detecting the parameters of the agitator itself are arranged at points where high mechanical loads occur, and sensors detecting parameters of a concentration of the substances to be circulated are arranged in the vicinity of extremities of a rotating circulator of the agitator.

Thereby, the suggested agitator is configured to move within a vessel in order to circulate at least one substance, wherein the agitator comprises at least one sensor which is configured to detect parameters of the circulating process and/or parameters of the substance and/or parameters of a reaction and/or parameters of the agitator, for example for monitoring the apparatus, and wherein the agitator is configured to transmit sensor signals of the at least one sensor to an evaluating device in a wireless manner. A particular advantage of this agitator is that its design is less complex compared to conventional agitators or agitators with sensors. As a result, installation space can be saved and a chemical reactor provided with such an agitator can be used more efficiently. The possibility of providing the agitator with a plurality of sensors means that measurements can be made with particular precision. An advantageous aspect of the measurement with different sensors is that a plausibility check of the individual measurements among each other or with each other may also be carried out. In this context, it is useful to arrange the individual sensors at different points of the agitator. For example, it is recommended to arrange sensors that detect parameters of the agitator itself at points where, for example, high mechanical loads occur. In this way, the agitator can be operated optimally below its mechanical load capacity. Temperature sensors or sensors that are able to detect parameters of a concentration of the substances to be circulated should be arranged, for example, in the vicinity of extremities of a rotating circulator of the agitator, since the substances moved by the agitator are driven, due to their inertia, by a centrifugal force of the rotating circulator into edge regions of a vessel receiving the same.

A further aspect of the invention relates to agitator system including: an agitator as mentioned above and described below in further embodiments; a vessel configured to receive the agitator and the substance to be circulated by the agitator; a drive configured to drive the agitator.

Still another aspect of the invention relates to a method for agitating or circulating at least one substance, wherein an agitator, as mentioned above and described below in further embodiments, is moved, for example rotated, within a vessel in order to circulate at least one substance, and wherein, during movement of the agitator, a sensor signal received by a sensor arranged in or at the agitator is transmitted to an evaluating device in a wireless manner.

The advantages or technical effects applicable to the agitator according to its various embodiments also apply to the agitator system provided with such an agitator, as well as to the method of operation for the detection of parameters with such an agitator or agitator system and vice versa.

According to an advantageous embodiment, the agitator is configured to receive energy which may be used for operating the at least one sensor in a wireless manner. Due to the wireless design, the freedom of movement of the agitator is larger compared to a traditional wired design. Furthermore, an agitator having a sensor that is able to receive energy in a wireless manner may also be manufactured in a more compact manner than conventional agitators. It is particularly advantageous to supply the sensor inductively or inductively resonantly with energy in a near field. Alternatively or alternatively, the sensor may also be operated by means of an electric field in the UHF range. The contactless transmission of the sensor's parameters is performed via electromagnetic waves in the near field and/or far field.

In addition or alternatively to wirelessly supplying energy to the sensor, according to yet another advantageous embodiment, the agitator includes a transmission device which is configured to output and/or transmit the detected parameters in a wireless manner. A contactless transmission of the parameters of the sensor is possible, for example, via electromagnetic waves in a near field and/or far field. By contactless or wireless integration of a transmission device into the agitator, installation space may additionally be saved, which extraordinarily increases the agitator's freedom of movement. Such an embodiment may maximize the degree of compactness of the agitator and minimize a complexity of sensors and components of the agitator to be interconnected.

It is advantageous that the at least one sensor is configured to detect the parameters in a continuous or intermittent manner. Continuous detection of parameters is particularly advantageous when the substances circulated or mixed with the agitator react quickly, in other words, reaction speed of the circulated substances is high. Intermittent detection of parameters is especially advantageous when the reaction speed of the circulated substances is low. As a result, the amount of measured data may be minimized, and thereby a useful energy input for detecting or transmitting parameter data may also be reduced. Furthermore, during intermittent operation of the agitator, it is possible to alternately supply the sensor with energy and/or to detect and/or transmit parameters using the sensor.

In a particularly diverse embodiment of the agitator, the at least one sensor is configured to detect/sense one or more of the following parameters such as: temperature, pressure, humidity, magnetic field strength/flux, pH-value, acceleration, concentration of a substance or mixture of substances, and the like. Thus, flexibility when using the sensor may be optimized or increased.

In a particularly advantageous embodiment of the agitator, the agitator is configured to be driven in a contactless manner. Such driving may, for example, be inductive or magnetic by means of an alternating field. This embodiment is again particularly advantageous if the agitator may be configured to be particularly compact and space-saving. Furthermore, in connection with previously described embodiments, it allows a complete contactless integration into a vessel of a reactor or into the substance to be circulated or mixed. This minimizes an effect of external influences on the reaction or on the substances to be circulated.

In a particularly compact embodiment, the agitator comprises a circulator for circulating the substances, and a coupling device connected to the circulator in a first region thereof and comprising a second region of the coupling device spaced apart from the first region, the device being configured to be coupled to an antenna for transmitting sensor signals and/or energy and/or a mechanical drive. In this embodiment, for example, driving the circulator may be performed using an axle which is coupled to the circulator. In this case, coupling is performed in a second region of the circulator, the second region being connected to the first region of the circulator. Furthermore, the second region may be arranged to be coupled to an antenna for transmitting sensor signals and/or energy. This provides the coupling device of the agitator with two dedicated regions for different specific tasks. This is particularly advantageous because different suitable materials may be selected when designing the agitator, taking into account its specific tasks or task areas. For example, corrosion-resistant and mechanically resilient materials are used for the first region which is connected to the circulator, since the circulator is in direct contact with the materials to be circulated. For the transmission of energy or sensor signals, materials may be used that are able to conduct and/or transmit electromagnetic signals particularly well.

In yet another advantageous embodiment, only the first region of the coupling device of the agitator is configured to be immersed in a substance to be agitated. Since certain substance compositions cause strong attenuation of the sensor signals to be transmitted, the parameters detected by the agitator or its circulator may be transmitted as lossless as possible, so that a measurement as reliable as possible can be ensured. For this purpose, the second region of the coupling device, which is assigned for the transmission of sensor signals and/or energy for the sensors, should be kept as far away as possible from negative influences—signal attenuation—of the substances to be circulated. It is noted that in the case of strongly aqueous solutions, only the second region still provides satisfactory transmission performance for the signals of the coupling region of the agitator transmitted by the sensor.

Conveniently, the antenna for transmitting sensor signals is arranged closer to the second region of the coupling device having the mechanical drive than the at least one sensor.

Such an arrangement is advantageous when the sensor is located below a substance level. If an antenna were located below the substance level of the substance to be circulated, then transmission of the sensor signals would no longer be reliable.

According to an advantageous embodiment, the agitator system comprises a transmission device with a stationary antenna coupled to an evaluating device. The stationary antenna may be used to ensure wireless coupling of the sensors of the agitator to an evaluating device. For example, a stationary antenna may be used for an agitator when the agitator is located within a vessel made of an electrically conductive material—Faraday cage. In particular, an arrangement of the stationary antenna in the second region of the coupling device which is located outside the substances to be circulated, ensures that there is no interference with the sensor signals to be transmitted. In addition, the arrangement of the stationary antenna in the second region of the coupling device may also prevent the antenna from influencing the properties of the substances to be circulated or the reacting substances. The antenna may be used simultaneously for transmitting the sensor signals as well as for transmitting energy to the sensors within the agitator. This eliminates the need to provide the agitator with energy storage devices, such as batteries, which would be useful to feed the sensors in the agitator. As a result, the agitator may be designed more compact, while the complexity of its components is reduced, thus also reducing the fault susceptibility of the agitator or the agitator system; after all, the batteries accommodated in agitators fail at high temperatures, in which case it is no longer possible to detect parameters of the sensor or to transmit signals.

According to a particular embodiment of the agitator system, the stationary antenna is arranged around a mechanical coupling device, for example concentrically. Alternatively or additionally, the stationary antenna comprises a winding arranged around the mechanical coupling device. Thus, an antenna for transmitting signals and/or energy of the sensors of the agitator may be implemented in the most simple way.

According to another particular embodiment of the agitator system, the agitator comprises an antenna arranged around the mechanical coupling device for transmitting the sensor signals to the stationary antenna. Such an arrangement is particularly advantageous if the coupling device is configured as a driving axle of the circulator. In this case, an antenna for transmitting signals and/or energy of the sensors of the agitator may be implemented in the most simple way by the antenna comprising a winding arranged around the mechanical coupling device.

It is useful to arrange an antenna of the agitator and an antenna coupled to the evaluating device such that an electrically non-conductive region of the vessel is located between the antennas. This may ensure that a transmission is possible without cable or contacting. For example, in the case of a corresponding viewing window in a vessel accommodating the agitator, the viewing window may be located between the stationary transmitter/receiver or the sensor and the antenna of the evaluating device. This provides a secure hermetic separation between the vessel interior and an external environment around the vessel without cable bushing. In addition, the stationary antenna of the sensor may also be located outside the vessel if transmission from the sensor to the stationary antenna of the sensor is possible via a viewing window.

In order to avoid mutual interference of the agitator and/or its transmission device with the substances to be circulated, the antenna of the agitator and/or the antenna of the evaluating device are surrounded by an enclosure made of a mechanically and/or chemically resistant material—relating to the at least one substance to be circulated. Enclosing the antenna of the evaluating device and/or the antenna of the sensor system with a chemically resistant material, for example Teflon, may protect the antenna of the evaluating device and/or the antenna of the sensor system from reacting substances and thus ensure reliable transmission of signals and parameters of the sensor, respectively.

For effective testing and evaluating parameters of the agitator or the circulated substances and their reaction, the agitator system includes an evaluating device which is established to evaluate the parameters detected by the at least one sensor. This makes it possible not only to detect the parameters of the reaction, but also to control the agitator system itself or the agitator, for example by moving the agitator more slowly in order to influence the reaction itself. Depending on the determined parameters, the entire reaction process of the substances circulated by the agitator can thus be specifically monitored and/or simultaneously controlled. For example, a process temperature within a chemical reactor provided with the agitator could be controlled by means of a heating device of the reactor.

To increase flexibility when using the agitator system, the evaluating device is configured to receive the parameters transmitted by the transmission device of the agitator in a contactless manner.

According to a particularly advantageous embodiment, the drive of the agitator is configured to drive the agitator in a contactless manner. This may increase the degree of freedom of movement and flexibility when using the agitator. The agitator itself may be made more compact. Suitable drives for this may be magnetic and electric-inductive. These are particularly robust and easy to maintain and also save costs. Maintenance of the agitator itself is also easier. Furthermore, a contactless drive may be used for a variety of different agitators increasing the efficiency when using such a drive.

In order to ensure the most reliable possible transmission of sensor signals during the circulation of substances, wherein, during movement of the agitator, the sensor being arranged in or at the agitator is located in a region of the agitator which is surrounded by the at least one substance to be circulated, wherein, at least during movement of the agitator, but optionally also in the resting state, an antenna via which the sensor signals are transmitted to the evaluating device in a wireless manner, is located at least partially outside a region which is surrounded by the at least one substance to be circulated, for example above a substance level of the substance to be circulated.

With the help of the agitator or agitator system described above, parameters of the substances to be circulated and their reaction with each other may be detected and evaluated in a particularly advantageous manner.

### BRIEF DESCRIPTION OF THE DRAWINGS

Embodiments of the present invention will be detailed subsequently referring to the appended drawings, in which:

FIG. 1 shows a perspective view of an agitator according to an embodiment;

FIG. 2 shows a perspective view of an agitator system with an agitator according to an advantageous embodiment.

### DETAILED DESCRIPTION OF THE INVENTION

In the following, embodiments are described in more detail with reference to the figures, with elements having the same or similar function being indicated by the same reference signs.

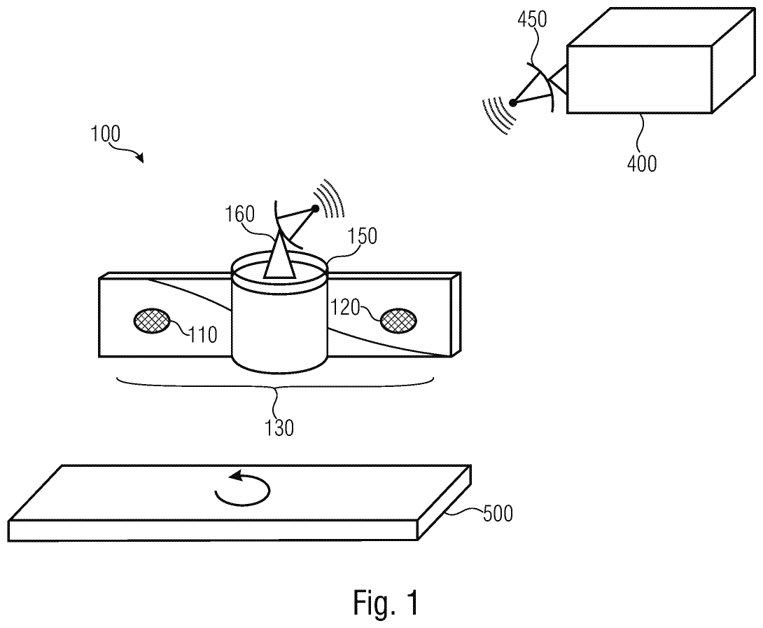

In FIG. 1, a highly simplified embodiment of an agitator 100 according to an embodiment of the invention is shown. The agitator 100 includes two sensors 110, 120 arranged at/in blades or paddles of the agitator 100. The blades or paddles form a circulator 130 of the agitator 100 for the at least one substance to be circulated. The number of sensors 110, 120 is not reduced to two, but may be increased or decreased to meet the needs for detecting and evaluating useful parameters. The two sensors 110 and 120, respectively, may be sensors of the same type or of different types. In the case of sensors 110, 120 of the same type, for example, a plausibility check may be performed during the detection and evaluation of the parameters detected by the sensors 110, 120. A plausibility check is also possible if the parameters of the respective sensors 110, 120 are in a causal relationship. The agitator 100 shown in FIG. 1 has a coupling device 150 which may be used to connect the agitator to a mechanical drive, for example. In the illustrated embodiment of FIG. 1, the agitator 100 may be driven by, for example, a magnetic or electric inductive drive 500 without having to be coupled to a drive via a mechanical connection. The drive 500 is shown in FIG. 1 in a highly simplified form as a plate. A contactless drive 500 is particularly advantageous when, due to contact of a substance to be circulated with the agitator 100 or its drive, an undesired interaction occurs which could influence parameters detected by the sensors 110, 120. In addition, the agitator 100 according to the embodiment of FIG. 1 may be configured to be particularly compact. In the present embodiment of FIG. 1, the agitator 100 further comprises a transmission device 160, with which a contactless transmission of signals or of the parameters detected by the sensors 110, 120 is possible. The coupling device 150 is additionally or alternatively configured to receive energy for the sensors 110, 120 and/or the transmission device 160. This is particularly advantageous as it eliminates the need for batteries in the agitator 100 which would be destroyed at high temperatures. The transmission device 160 is configured to transmit the detected parameters of the sensors 110, 120 to an evaluating device 400 for further processing—for example, via an antenna 450. In the present embodiment of FIG. 1, the transmission device 160 is configured as a wireless transmitter or transmitter-receiver.

In another embodiment not shown here, the coupling device 150 and the transmission device 160 are one single device. In intermittent operation, this single device may then, for example, transmit energy and transmit parameters simultaneously. This may again save installation space which may be used, for example, for further sensors to be accommodated in the agitator 100. Alternatively, the agitator 100 may be made even more compact and smaller compared to such agitators that are powered by a battery.

Furthermore, in yet another embodiment not shown here, installation space saved due to the lack of batteries can be provided for the accommodation of a calculation logic, wherein the detected parameters of the sensors 110, 120 are already evaluated by the calculation logic integrated in the agitator 100 and may be transmitted directly to an evaluating device 400.

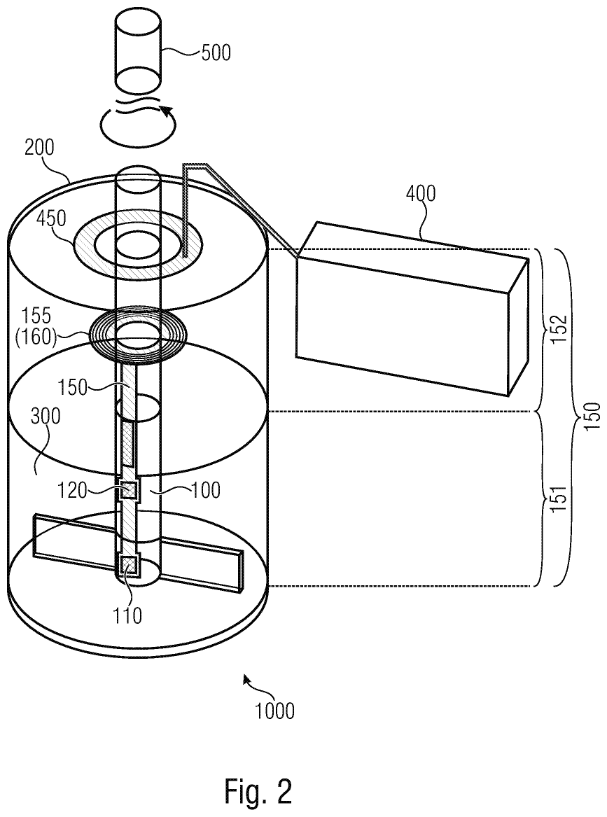

FIG. 2 illustrates another embodiment of an agitator 100 integrated into an agitator system 1000. Furthermore, the agitator system includes a vessel 200 which is configured to receive the agitator 100 and the substances 300 to be circulated by the agitator 100. The agitator system 1000 further includes a drive 500, which is indicated in FIG. 2 as an interrupted axle—having a predetermined direction of rotation. The drive 500 may be, for example, an electric motor that drives the axle of the agitator 100. Furthermore, the agitator system 1000 comprises an evaluating device 400 which may, via a stationary antenna 450 as coupling device be coupled to a stationary antenna 155 of the coupling device 150 of the agitator 100. In the present case, the antenna 450 of the evaluating device 400 or the antenna 155 of the agitator 100 is stationary and arranged coaxially or concentrically around the driving axle of the agitator 100. Such an arrangement is advantageous if the agitator 100 or its sensors 110, 120 are located in an electrically conductive vessel 200, for example a metallic vessel. For contactless or wireless transmission, there should be no electrically conductive wall between the transmission device 160 and the evaluating device 400. In the present embodiment of FIG. 2, the vessel 200 is a metallic cylinder in which at least one substance 300 is circulated by the blades or paddles of the agitator 100. In this case, the agitator 100 comprises a circulator 130 with two blades and an axle which is connected to the agitator 100 and may be mechanically connected to the drive 500. In this case, the sensors 110, 120 are arranged in a region 151 of the axle of the drive 500 which is below a level of the at least one substance 300 to be circulated. In other words, a region 151 of the agitator 100 used for detecting the parameters of the substance 300 using the sensors 110, 120 is immersed in the substance 300. The coupling device 150 or antenna 160 for transmitting the sensor signals and/or energy is arranged in a region 152 above the substance level, so that the antenna 160 does not come into contact or is not in contact with the substance 300.

The coupling device 150 of the agitator 100 is configured to receive energy for the sensors 110, 120 and to transmit energy to them. Accordingly, it is not necessary in the embodiment according to FIG. 2 to provide batteries in the vicinity of the sensors 110, 120. As already described above, batteries may be destroyed especially at high temperatures of the substances 300 to be circulated, which can occur, for example, during an exothermic reaction, whereby detection and transmission of parameters that are detected by the sensors 110, 120 is no longer possible.

The signals or parameters of the substances 300 received by the evaluating device 400 may be evaluated for further use and/or may serve to control the circulating process within the vessel 200 of the agitator system 1000. For example, according to an advantageous embodiment, a reaction of one or more substances 300 taking place in the vessel 200 may be influenced in real time, by the evaluating device 400 controlling the drive 500 of the agitator 100 or a heating device of the vessel 200 via an interface—not shown here.

According to another advantageous embodiment, the agitator 100, the coupling device 150 and the antenna 155 of the agitator 100, respectively, and/or the antenna 450 of the evaluating device 400 may be protected from reactive substances 300 by enclosing the same with a chemically and/or mechanically resistant material.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An agitator,
wherein the agitator is configured to move within a vessel in order to circulate at least one substance,
wherein the agitator comprises at least one sensor which is configured to detect parameters of the circulating process and/or parameters of the substance and/or parameters of a reaction and/or parameters of the agitator, and
wherein the agitator is configured to transmit sensor signals of the at least one sensor to an evaluating device in a wireless manner, wherein the at least one sensor is configured to detect the parameters in an intermittent manner, wherein
the agitator comprises at least one further sensor being configured to detect parameters of the circulating process and/or detect parameters of the agitator, wherein
the sensors are arranged at different points of the agitator, and sensors detecting the parameters of the agitator itself are arranged at points where high mechanical loads occur, and sensors detecting parameters of a concentration of the substances to be circulated are arranged in the vicinity of extremities of a rotating circulator of the agitator.

2. The agitator according to claim 1,
wherein the agitator is configured to receive an energy which may be used for operating the at least one sensor in a wireless manner.

3. The agitator according to claim 1,
wherein the agitator comprises a transmission device which is configured to output and/or transmit the detected parameters in a wireless manner.

4. The agitator according to claim 1,
wherein the at least one sensor is configured to detect one or more of the following parameters such as: temperature, pressure, humidity, magnetic field strength/flux, pH-value, acceleration, concentration of a substance or mixture of substances, and the like.

5. The agitator according to claim 1,
wherein the agitator is configured to be driven in a contactless manner.

6. The agitator according to claim 1, comprising:
a circulator;
a coupling device connected to the circulator in a first region thereof and comprising a second region of the coupling device spaced apart from the first region, the device being configured
to be coupled to an antenna for transmitting sensor signals and/or energy
and/or a mechanical drive.

7. The agitator according to claim 6,
wherein only the first region of the coupling device is configured to be immersed in a substance to be agitated.

8. The agitator according to claim 6,
wherein the antenna for transmitting sensor signals is arranged closer to the second region of the coupling device comprising the mechanical drive than the at least one sensor.

9. An agitator system comprising:
an agitator according to claim 1;
a vessel configured to receive the agitator and the substances to be agitated by the agitator;
a drive configured drive the agitator.

10. The agitator system according to claim 9,
wherein the agitator system comprises a transmission device with a stationary antenna coupled to an evaluating device.

11. The agitator system according to claim 10,
wherein the stationary antenna is arranged around a mechanical coupling device, and/or
wherein the stationary antenna comprises a winding arranged around the mechanical coupling device.

12. The agitator system according to claim 9,
wherein the agitator comprises an antenna arranged around the mechanical coupling device for transmitting the sensor signals to the stationary antenna;
and/or
wherein the agitator comprises an antenna for transmitting the sensor signals to the stationary antenna comprising a winding arranged around the mechanical coupling device.

13. The agitator system according to claim 10,
wherein an antenna of the agitator and an antenna coupled to the evaluating device are arranged such that an electric non-conductive region of the vessel is located between the antennas.

14. The agitator system according to claim 10,
wherein the antenna of the agitator and/or the antenna of the evaluating device are surrounded by an enclosure made of a mechanically and/or chemically resistant material.

15. The agitator system according to claim 10,
wherein the agitator system comprises an evaluating device which is established to evaluate the parameters detected by the at least one sensor.

16. The agitator system according to claim 10,
wherein the evaluating device is configured to receive the parameters being transmitted by the transmission device of the agitator in a contactless manner.

17. The agitator system according to claim 9,
wherein the drive is configured to drive the agitator in a contactless manner.

18. A method for agitating at least one substance,
wherein an agitator according to claim 1 is moved within a vessel in order to circulate at least one substance, and
wherein, during movement of the agitator, a sensor signal received by a sensor arranged in or at the agitator is transmitted to an evaluating device in a wireless manner,
wherein the at least one sensor detects the parameters in an intermittent manner, wherein
at least one further sensor detects parameters of the circulating process and/or detect parameters of the agitator, wherein
the sensors are arranged at different points of the agitator, and sensors detecting the parameters of the agitator itself are arranged at points where high mechanical loads occur, and sensors detecting parameters of a concentration of the substances to be circulated are arranged in the vicinity of extremities of a rotating circulator of the agitator.

19. The method according to claim 18,
wherein, during movement of the agitator, the sensor being arranged in or at the agitator is located in a region of the agitator which is surrounded by the at least one substance to be agitated, and
wherein, at least during movement of the agitator, an antenna via which the sensor signals are transmitted to the evaluating device in a wireless manner, is located at least partially outside a region which is surrounded by the at least one substance to be agitated.
